(19) United States
(12) Patent Application Publication
(10) Pub. No.: US 2026/0303263 A1
(43) Pub. Date: Oct. 1, 2026

(54) WIRELESS AUDIO TRANSMISSION METHOD, AUDIO DEVICE, AND NON-TRANSITORY COMPUTER-READABLE STORAGE MEDIUM

(71) Applicant: Questyle Audio Technology Co., Ltd, Shenzhen (CN)

(72) Inventor: Fengshuo WANG, Shenzhen (CN)

(73) Assignee: Questyle Audio Technology Co., Ltd, Shenzhen (CN)

(21) Appl. No.: 19/567,057

(22) Filed: Mar. 14, 2026

Related U.S. Application Data
(63) Continuation of application No. PCT/CN2023/122316, filed on Sep. 27, 2023.

(30) Foreign Application Priority Data
Sep. 15, 2023 (CN) 2023112083080

(51) Int. Cl. H04L 1/1607; H04L 5/00; H04W 28/04

(52) U.S. Cl. CPC H04L 1/1607; H04L 5/0055; H04W 28/04

(57) ABSTRACT

The disclosure provides a wireless audio transmission method, an audio device, and a non-transitory computer-readable storage medium. The disclosure first obtains the maximum duration T₁ from when the transmitting end transmits an audio packet to when the transmitting end receives an acknowledgment packet fed back by the receiving end, as well as the duration difference T₀ between the transmission times of two adjacent audio packets transmitted by the transmitting end. When facing the possibility of packet loss and retransmission, the transmitting end determines the quantity of retransmissions based on the maximum duration T₁ and the duration difference T₀, making the quantity of retransmissions more suitable for the actual audio transmission scenario. This can reduce the transmission latency and ensure audio quality.

### CROSS REFERENCE TO RELATED APPLICATION

The disclosure is a Continuation of PCT Patent Application No. PCT/CN2023/122316, filed on Sep. 27, 2023, which claims priority of China Patent Application No. CN2023112083080 filed on Sep. 15, 2023. The contents of the above-identified applications are incorporated herein by reference.

### TECHNICAL FIELD

The disclosure relates to the field of audio transmission technology, in particular, to a wireless audio transmission method, an audio device, and a non-transitory computer-readable storage medium.

### BACKGROUND

With the widespread application of audio technology, wide variety of application scenarios have emerged. For some specialized applications, wireless audio transmission is required to have ultra-low latency. For example, in e-sports gaming scenarios, demand near-perfect synchronization between game visuals and the sound transmitted to headphones worn by the user during gameplay. Currently, mainstream wireless audio transmission solutions in the market are mainly based on Bluetooth technology. However, its latency thereof is generally above 200 ms; and even after optimization by some manufacturers, the latency still remains at approximately 80 ms. Such relatively high latency makes it difficult to satisfy the requirements of high-performance wireless audio transmission, thus adversely affecting user experience.

Therefore, there remains room for improvement in audio transmission performance.

### SUMARRY

In view of the above, the disclosure provides a wireless audio transmission method, an audio device, and a non-transitory computer-readable storage medium that can address the issue of relatively high latency in existing wireless audio transmission.

The disclosure provides a wireless audio transmission method, comprising: a transmitting end transmitting a current audio packet to a receiving end; the transmitting end obtaining a maximum duration T₁ and a duration difference T₀, wherein the maximum duration T₁ refers to a duration from a time when the transmitting end transmits an audio packet to a time when the transmitting end receives an acknowledgment packet fed back by the receiving end, the duration difference T₀ refers to a difference between transmission times of two adjacent audio packets transmitted by the transmitting end; the transmitting end determining whether the acknowledgment packet is received within the maximum duration T₁; if the acknowledgment packet is received within the maximum duration T₁, the transmitting end transmitting a next audio packet to the receiving end; if acknowledgment packet is not received within the maximum duration T₁, the transmitting end determining a quantity of retransmissions of the current audio packet based on the maximum duration T₁ and the duration difference T₀, and performing the determined quantity of retransmissions; and after confirming that the determined quantity of retransmissions are completed, the transmitting end transmitting the next audio packet to the receiving end.

In some other embodiments, the step of the transmitting end determining a quantity of retransmissions of the current audio packet based on the maximum duration T₁ and the duration difference T₀, and performing the determined quantity of retransmissions comprises: determining that if T₁≤T₀/2, the quantity of retransmissions of the current audio packet is set to be 1, or determining that (T₁*n)≤T₀, wherein n is the quantity of retransmissions of the current audio packet.

In some other embodiments, the step of the transmitting end determining the quantity of retransmissions of the current audio packet based on the maximum duration T₁ and the duration difference T₀, and performing the determined quantity of retransmissions comprises: determining that if T₁>T₀/2, the quantity of retransmissions of the current audio packet is set to be 1.

In some other embodiments, the step of the transmitting end determining the quantity of retransmissions of the current audio packet based on the maximum duration T₁ and the duration difference T₀, and performing the determined quantity of retransmissions further comprising: determining that if T₁>T₀/2, determining that a sum of the occupied storage of audio data of the retransmissions is equal to a buffer of the receiving end, or a difference between the sum of the occupied storage of audio data of the retransmissions and the buffer of the receiving end is less than the occupied storage of the audio data in the current audio packet.

In some other embodiments, the step of the transmitting end obtaining a maximum duration T₁ and a duration difference T₀ comprises: obtaining the maximum duration T₁ and the duration difference T₀ according to a predetermined correspondence relationship; wherein the step of the transmitting end determining the quantity of retransmissions of the current audio packet based on the maximum duration T₁ and the duration difference T₀, and performing the determined quantity of retransmissions comprises: determining the quantity of retransmissions of the current audio packet according to the following relationship formula: T₂=T₀+((T₁*n)//T₀+1)*T₀+T₃, wherein T₂ refers to the latency duration, T₃ refers to the duration from the time when the transmitting end transmits an audio packet to the time when the receiving end receives the audio packet, and n refers to the quantity of retransmissions of the current audio packet.

In some other embodiments, during step of performing the determined quantity of retransmissions is executed, the receiving end does not feed back the acknowledgment packet, and the duration difference between two adjacent retransmissions is T₁-T₄, wherein T₄ is the transmission duration of the acknowledgment packet.

In some other embodiments, the wireless audio transmission method further comprises: after determining that the determined quantity of retransmissions are completed, and if the receiving end has not received the current audio packet, copying the audio data of the previous audio packet and using the copied audio data as the audio data of the current audio packet.

In some other embodiments, during step of performing the determined quantity of retransmissions, the transmitting end performs lossless encoding on the audio data of the current audio packet and then performs retransmission.

This disclosure further provides an audio device, comprising a memory and a processor. The memory stores an audio transmission program, and when the audio transmission program is executed by the processor, the steps of the wireless audio transmission method as described above are implemented.

This disclosure further provides a non-transitory computer-readable storage medium, on which a computer program is stored. When the computer program is executed by a processor, the steps of the wireless audio transmission method as described above are implemented.

As described above, the disclosure first obtains the maximum duration T₁ from when the transmitting end transmits an audio packet to when the transmitting end receives an acknowledgment packet fed back by the receiving end, as well as the duration difference T₀ between the transmission times of two adjacent audio packets transmitted by the transmitting end. When facing the possibility of packet loss and retransmission, the transmitting end determines the quantity of retransmissions based on the maximum duration T₁ and the duration difference T₀, making the quantity of retransmissions more suitable for the actual audio transmission scenario. This can reduce the transmission latency and ensure audio quality.

### BRIEF DESCRIPTION OF THE DRAWINGS

FIG. 1 is a schematic flowchart of a wireless audio transmission method provided in an embodiment of the disclosure.

FIG. 2 is a schematic diagram of the retransmission of an audio packet provided in an embodiment of the disclosure.

FIG. 3 is another schematic diagram of the retransmission of an audio packet provided in an embodiment of the disclosure.

FIG. 4 is yet another schematic diagram of the retransmission of an audio packet provided in an embodiment of the disclosure.

### DETAILED DESCRIPTION OF THE EMBODIMENTS

To solve the foregoing problems in the prior art, the disclosure provides a wireless audio transmission method, an audio device, and a non-transitory computer-readable storage medium. These claimed subject matters are based on the same inventive concept, and the problem-solving principles thereof are substantially identical or similar. The implementations of the respective claimed subject matters may be referred to one another, and repeated descriptions are omitted herein for brevity.

To clarify the objectives, technical solutions, and advantages of the disclosure, the technical solutions of the disclosure will be clearly described below in conjunction with specific embodiments and the corresponding accompanying drawings. Obviously, the embodiments described below are merely a part of the embodiments of the disclosure, rather than all of the embodiments thereof. In the absence of conflicts, the various embodiments described below and their technical features may be combined with each other, and all such combinations shall also fall within the scope of the technical solutions of the disclosure.

In the description of the embodiments of the disclosure, terms such as “center,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” and “counterclockwise” etc., indicate orientation or positional relationships based on those shown in the accompanying drawings. These terms are merely used to facilitate the description of the technical solutions of the respective embodiments, and do not imply or indicate that the device or element must have a specific orientation, or be constructed and operated in a specific orientation; thus, they shall not be construed as limitations on the disclosure.

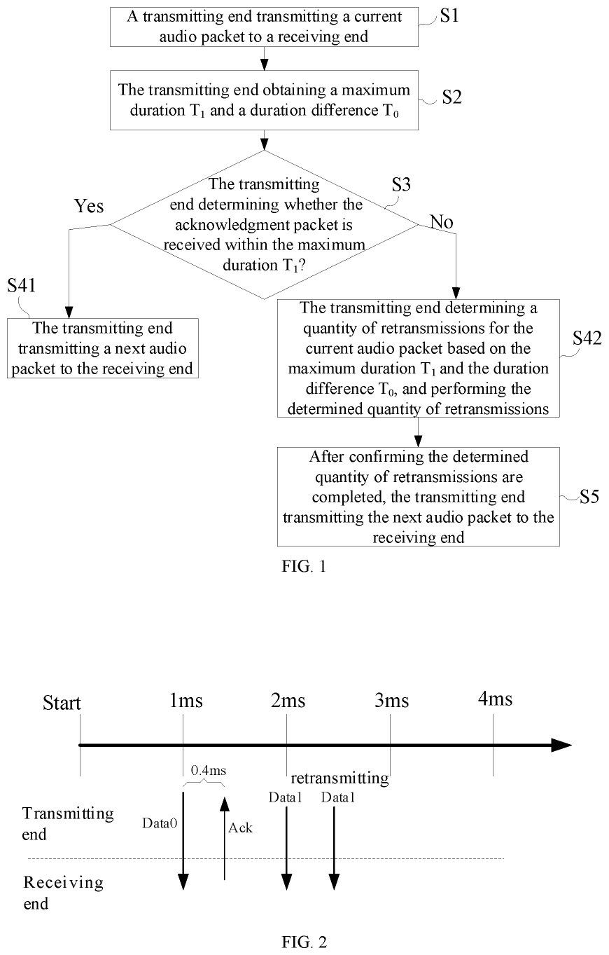

Referring to FIG. 1, an embodiment of the disclosure provides a wireless audio transmission method, wherein the executing entity of each step may be a transmitting end, and the wireless audio transmission method includes at least the following steps S1 to S5.

In the step S1: a transmitting end transmits a current audio packet to a receiving end.

In some embodiment, the wireless audio transmission method is applied to an audio transmitting device and is configured to implement pairing and connection with at least one audio receiving device, thereby forming an audio transmission system. The audio transmission system can have a one-to-one relationship (one audio transmitting device corresponds to one audio receiving device) or one-to-many relationship (one audio transmitting device corresponds to a plurality of audio receiving devices). Wherein the audio transmitting device may serve as the transmitting end, and the audio receiving device serve as the receiving end. The wireless audio transmission method provided in the disclosure may be based on Ultra Wide Band (UWB) technology. UWB technology has advantages including low system complexity, low power spectral density of the transmitted signal, insensitivity to channel fading, low interception capability, and high positioning accuracy, which makes it particularly suitable for high-speed wireless access in dense multipath environments such as indoor environments. Therefore, the devices connected through the wireless audio transmission method provided in the disclosure can achieve high-level, high-fidelity, and low-latency wireless audio transmission by adopting UWB technology.

In one example, the transmitting end may first enter a pairing mode and further set current preamble sequence information (e.g., a preamble code). Specifically, the preamble sequence information may be set as characters for pairing, for instance, set to 30. The preamble sequence information refers to a series of signals transmitted before transmitting valid signals, and its function is to remind the receiving end that the valid signals are to be transmitted, prompting the receiving end to pay attention to reception so as to avoid loss of the valid signals. More specifically, it assists the receiving end in performing controls such as frequency synchronization and automatic gain control.

The audio packet contains the audio data to be transmitted and also includes other necessary information. The specific manifestation and frame structure of the audio packet may refer to the prior art, and will not be described in detail herein.

In the step S2: the transmitting end obtains a maximum duration T₁ and a duration difference T₀, the maximum duration T₁ refers a duration from a time when the transmitting end transmits an audio packet to a time when the transmitting end receives an acknowledgment packet fed back by the receiving end, the duration difference T₀ refers to a difference between transmission times of two adjacent audio packets transmitted by the transmitting end.

Referring to FIGS. 2 to 4 together, assume that the transmitting end transmits the audio packet every 1 ms. Then, it must accumulate audio data for 1 ms from the beginning and then start transmission; this 1 ms is the duration difference T₀ between the transmitting end transmitting two adjacent audio packets. After the transmitting end transmits the audio packet each time, if the receiving end receives the audio packet, it will return an acknowledgment packet (i.e., Ack) to the transmitting end; if the transmitting end does not receive the acknowledgment packet fed back by the receiving end within a certain time, the transmitting end will retransmit the same data, that is, transmit the current audio packet again. Taking FIG. 2 as an example, the maximum duration T₁ from when the transmitting end transmits the audio packet to when it receives an acknowledgment packet fed back by the receiving end is 0.4 ms, then this certain time is 0.4 ms. In actual scenarios, it can be appropriately slightly longer than 0.4 ms to allow for fluctuations.

It should be understood that the so-called maximum duration T₁ refers to the time actually perceived by the upper-layer application, including: the duration from when the upper-layer application of the transmitting end transmits data to the system Radio Frequency(RF) for transmission, the duration required by the protocol to complete an actual transmission, the duration for transmitting the audio packet over the air, the duration for the receiving end to feed back the acknowledgment packet, the duration for the transmitting end to receive the acknowledgment packet, and the duration for the RF of the transmitting end to return the acknowledgment to its upper-layer application layer.

During audio transmission process, the roles of the transmitting end and the receiving end switch dynamically. For example, as shown in FIG. 2, after the transmitting end has completed transmitting the audio packet, the transmitting end switches its role to the receiving end to await an acknowledgment packet at the 1 ms mark. Conversely the receiving end switches its role to the transmitting end and transmit the acknowledgment packet upon receiving the audio packet and switch back to the receiving end thereafter. This process cycles repeatedly until the audio transmission is completed.

In the case of retransmission, after the original transmitting end switches its role to the receiving end, if it fails to receive the acknowledgment packet within the maximum duration T₁, it will transmit the original audio packet again.

In the step S3: the transmitting end determines whether the acknowledgment packet is received within the maximum duration T₁.

If the acknowledgment packet is received within the maximum duration T₁, the process proceeds to S41: the transmitting end transmits a next audio packet to the receiving end.

If the acknowledgment packet is not received within the maximum duration T₁, the process proceeds to S42: the transmitting end determines a quantity of retransmissions for the current audio packet based on the maximum duration T₁ and the duration difference T₀, and performs the determined quantity of retransmissions.

In the step S5: after confirming the determined quantity of retransmissions are completed, the transmitting end transmits the next audio packet to the receiving end.

Based on steps S2 and S42, the disclosure first obtains the maximum duration T₁(i.e., the duration from when the transmitting end transmits the audio packet to when the transmitting end receives an acknowledgment packet), and the duration difference T₀ (i.e., the difference between the transmission times of two adjacent audio packets transmitted by the transmitting end). When potential packet loss and retransmission occur, the quantity of retransmissions is determined according to this maximum duration T₁ and the duration difference T₀, such that the quantity of retransmissions is adaptive to the actual audio transmission scenario. This not only reduce latency but also ensures audio quality.

In an example, as shown in FIG. 2, if T₁ is 0.4 ms and T₀ is 1 ms, it can be determined that the maximum duration T₁ and the duration difference T₀ satisfy: T₁≤T₀/2. Then, it can be determined that the quantity of retransmissions for the current audio packet is 1, that is, one retransmission is performed. With a relatively small a quantity of retransmissions, latency can be reduced.

Furthermore, if the receiving end fails to receive the retransmitted current audio packet and thus does not feed back an acknowledgment packet to the transmitting end, the transmitting end will not receive the acknowledgment packet. To ensure audio quality, the receiving end, may adopt an appropriate packet loss compensation technique to perform packet loss compensation. For example, using Package Loss Concealment (PLC) technology, the audio data of the previous audio packet (i.e., the most recent audio packet for which the transmitting end successfully received the acknowledgment packet fed back by the receiving end before transmitting the current audio packet) is copied from a buffer of the receiving end and used as the audio data of the current audio packet.

In another embodiments, if the transmission efficiency of the audio transmission system is sufficiently high and the bandwidth is sufficiently large, and T₀ is several times T₁, for example, in an audio transmission scenario based on UWB technology, the quantity of retransmissions n may satisfy (T₁*n)≤T₀, that is, all retransmissions may be completed within the duration difference T₀ (i.e., 1 ms). In this case, the buffer of the receiving end may be relatively small or nearly free of additional buffering for audio transmission.

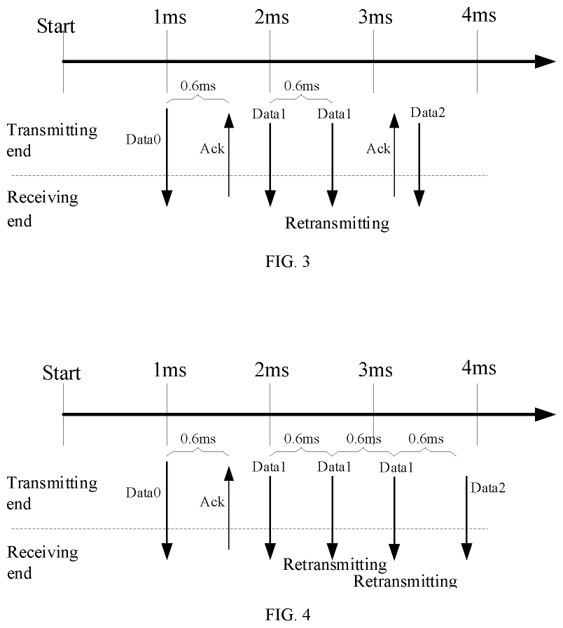

Referring to FIG. 3, if T₁ is 0.6 ms and T₀ is 1 ms, it can be determined that the maximum duration T₁ and the duration difference T₀ satisfy: T₁>T₀/2. Then, the the quantity of retransmissions for the current audio packet may be determined to be 1, that is, one retransmission is performed. With a relatively small quantity of retransmissions, transmission latency can be reduced.

In this example, the retransmission occupies the transmission time slot of the next audio packet. Originally, the audio packet Data2 must be transmitted at the 3 ms mark, however, due to retransmission, the transmission time slot becomes the retransmission time for the current audio packet Data1. Therefore, the transmitting end does not transmit the audio packet Data2 and instead continues to wait for the acknowledgment packet. If the acknowledgment packet is received within the maximum duration T₁, or if the maximum duration T₁ has elapsed regardless of whether the acknowledgment packet is received, the transmitting end transmits the next audio packet (i.e., the audio packet Data2) to the receiving end.

In another embodiment, as shown in FIG. 4, when it is determined that the maximum duration T₁ and the duration difference T₀ satisfy the condition: T₁>T₀/2, it may be determined that the sum of the storage occupied by the audio data of the retransmissions is equal to the buffer of the receiving end, or the difference between the sum of the storage occupied by the audio data of the retransmissions and the buffer of the receiving end is less than the storage occupied by the audio data in the current audio packet.

That is, if one retransmission is unsuccessful, the transmitting end may continue to occupy the transmission time slots of subsequent audio packets (including the next audio packet) and proceed with retransmission. However, this will result in delayed transmission of the subsequent audio packets. When multiple retransmissions are performed, to ensure that the receiving end can continue to play audio data during the transmission time slots of the subsequent audio packets, the receiving end must have sufficient buffering to store the audio data that should have been transmitted during these time slots. In other words, the transmitting end may continue to perform retransmissions, but the upper limit of the quantity of retransmissions is limited by the buffer of the receiving end.

In the examples shown in FIGS. 2 to 4, the overall latency of audio transmission is: 1 ms (i.e., T₀, the duration for which the transmitting end must buffer audio data) +transmission time +buffering time at the receiving end. Among them, the transmission time refers to the duration from when the transmitting end transmits the audio packet to when the receiving end receives the audio packet. In actual application scenarios, the data sizes of the acknowledgment packets fed back by the receiving end are the same, so the durations for feeding back each acknowledgment packet are consistent. Taking 0.07 ms as an example, the transmission time is T₁−0.07 ms. In addition, generally, to ensure smooth audio playback, the buffering time at the receiving end corresponds to the duration required for multiple retransmissions.

The disclosure may determine the quantity of retransmissions for the current audio packet according to the following relationship formula: T₂=T₀+((T₁*n)//T₀+1)*T₀+T₃. Wherein T₂ refers to the latency duration; T₃ refers to the duration from when the transmitting end transmits the audio packet to when the receiving end receives the audio packet, which is the transmission time; and n is the quantity of retransmissions for the current audio packet. In this relationship formula, (T₁*n)//T₀ is a positive integer obtained by integer division. For example, if T₀=1 ms, T₁=0.3 ms, and the quantity of retransmissions n=4, the buffering time at the receiving end is 2 ms. The calculation process is as follows: ((T₁*n)//T₀+1)*T₀=((0.3*4)//1+1)=(1.2//1+1)=2.

In actual application scenarios, if the duration difference T₀ is changed, the maximum duration T₁ will change accordingly. The relationship between the maximum duration T₁ and the duration difference T₀ is not linear because in addition to the actual audio data, each audio transmission also incurs some other overhead, such as the preamble sequence information and basic protocols. No matter how much storage the transmitted audio data occupies, the storage occupied by this overhead remains the same. For different audio transmission chips, the maximum duration T₁ and the duration difference T₀ may be different and must be tested according to the actual situation. In an example, the disclosure may obtain the maximum duration T₁ and the duration difference T₀ according to a preset correspondence relationship, which can be obtained based on the actual test results of multiple audio transmission chips. Each maximum duration T₁ has a corresponding duration difference T₀.

According to the relationship formula for calculating the buffering time at the receiving end, namely ((T₁*n)//T₀+1)*T₀, combined with the functional relationship formula for calculating the latency duration f(n), wherein f(n)=((T₁*n)//T₀+1)*T₀, the latency duration can be calculated by selecting different quantities of retransmissions n, different maximum durations T₁, and corresponding duration differences T₀. In other words, the disclosure may calculate the optimal maximum duration T₁ and the corresponding duration difference T₀ according to the latency duration that ensures the audio transmission and playback quality by adjusting different quantities of retransmissions n.

When performing the retransmission in S42, the receiving end may not feed back the acknowledgment packet, and the transmitting end continues to perform retransmissions. The duration difference between two adjacent retransmissions is T1-T4, wherein T₄ refers to the transmission duration of the acknowledgment packet.

In this case, according to T₂=T₀+((T₁*n)//T₀+1)*T₀+T₃, the maximum duration T₁ now only becomes the transmission time, that is, it becomes T₁-T₄. In some examples, if the result of (T₁*n)/T₀ just exceeds a certain integer (for example, the result may be 3.1), then the result of (T₁*n)//T₀ is 3; if the maximum duration T₁ now only serves as the transmission time (the time required for the acknowledgment packet is excluded), the result of (T₁*n)/T₀ will become 2.9, and the result of (T₁*n)//T₀ is 2, thereby reducing the latency duration.

When performing the retransmission in S42, if it is determined that the receiving end has not received the current audio packet after completing the specified quantity of retransmissions, the audio data of the previous audio packet is copied and used as the audio data of the current audio packet. That is, to ensure audio quality, the receiving end may adopt an appropriate packet loss compensation technique to perform the packet loss compensation. For example, by using PLC technology, the audio data of the previous audio packet (i.e., the most recent audio packet for which the transmitting end successfully received the acknowledgment packet fed back by the receiving end before transmitting the current audio packet) is copied from the buffer of the receiving end and used as the audio data of the current audio packet.

When performing the retransmission in S42, the transmitting end may also perform lossless encoding (Free Lossless Audio Code, FLAC, also known as lossless audio compression coding) on the audio data of the current audio packet and then retransmit the encoded audio data. Using lossless encoding at the transmitting end can reduce amount of data to be transmitted, effectively reduce a value of the maximum duration T₁, and also improve a success rate of transmission because the amount of data to be transmitted is smaller; a decoding rate at the receiving end is also relatively high. However, the overall latency result includes encoding and decoding times.

In actual application scenarios, since the transmitting end needs to accumulate a certain amount of audio data for encoding, the duration during which the system performing encoding buffers the audio data and performs one encoding operation (which may be referred to as the encoding buffering duration) may be the same as the optimal duration difference T₀ between the transmission times of two adjacent audio packets by the transmitting end. If the encoding buffering duration is greater than the optimal duration difference T₀, the optimal duration difference T₀ will be adjusted to the encoding buffering duration; if the encoding buffering duration is less than the optimal duration difference T₀, it is likely to reduce the encoding efficiency.

The embodiments of the disclosure also provide an audio device, which includes a memory and a processor. The memory stores an audio transmission program; when the audio transmission program is executed by the processor, the steps of the wireless audio transmission method as described in any of the above examples are implemented. The audio device may serve as the transmitting end or the receiving end described above, and the specific form of the audio device is not limited by the disclosure.

The embodiments of the disclosure also provide a non-transitory computer-readable storage medium. The non-transitory computer-readable storage medium stores a computer program. When the computer program is executed by a processor, the steps of the wireless audio transmission method as described in any of the examples are performed.

This non-transitory computer-readable storage medium may include: Read-Only Memory (ROM), Random Access Memory (RAM), magnetic disks, optical disks, etc.

Since the instructions stored in this non-transitory computer-readable storage medium can execute the steps of any of the wireless audio transmission methods provided in the embodiments of the disclosure, all the beneficial effects that can be achieved by any of the wireless audio transmission methods provided in the embodiments of the disclosure can be realized. For details, refer to the previous embodiments, which are not repeated here.

The above descriptions are only some embodiments of the disclosure and are not intended to limit the patent scope of the disclosure. For those skilled in the art, any equivalent structural transformations made by using the content of the present specification and the accompanying drawings shall also be included within the patent protection scope of the disclosure.

In the present text, step codes such as S1 and S2 are used to express the corresponding content more clearly and briefly and do not constitute a substantial limitation on the order. Those skilled in the art may perform S2 first and then S1 in specific implementations, but all such modifications shall be within the patent protection scope of the disclosure.

Although terms such as “first” and “second” are used in this text to describe various types of information, this information should not be limited to these terms. These terms are only used to distinguish the same type of information from each other. In addition, the singular forms “a”, “an”, and “the” are intended to include the plural forms as well. The terms “or” and “and/or” are interpreted as inclusive, meaning either one or any combination. An exception to this definition occurs only when the combination of elements, functions, steps, or operations is inherently mutually exclusive in some way.

1. A wireless audio transmission method, comprising:
a transmitting end transmitting a current audio packet to a receiving end;
the transmitting end obtaining a maximum duration T₁ and a duration difference T₀, wherein the maximum duration T₁ refers to a duration from a time when the transmitting end transmits an audio packet to a time when the transmitting end receives an acknowledgment packet fed back by the receiving end, the duration difference T₀ refers to a difference between transmission times of two adjacent audio packets transmitted by the transmitting end;
the transmitting end determining whether the acknowledgment packet is received within the maximum duration T₁;
if the acknowledgment packet is received within the maximum duration T₁, the transmitting end transmitting a next audio packet to the receiving end;
if the acknowledgment packet is not received within the maximum duration T₁, the transmitting end determining a quantity of retransmissions of the current audio packet based on the maximum duration T₁ and the duration difference T₀, and performing the determined quantity of retransmissions; and
after confirming that the determined quantity of retransmissions are completed, the transmitting end transmitting the next audio packet to the receiving end.

2. The wireless audio transmission method according to claim 1, wherein the step of the transmitting end determining the quantity of retransmissions of the current audio packet based on the maximum duration T₁ and the duration difference T₀ comprises:
determining that if T₁≤T₀/2, the quantity of retransmissions of the current audio packet is set to be 1, or determining that (T₁*n) ≤T₀, wherein n is the quantity of retransmissions of the current audio packet.

3. The wireless audio transmission method according to claim 1, wherein the step of the transmitting end determining the quantity of retransmissions of the current audio packet based on the maximum duration T₁ and the duration difference T₀ comprises:
determining that if T₁>T₀/2, the quantity of retransmissions of the current audio packet is set to be 1.

4. The wireless audio transmission method according to claim 1, wherein the step of the transmitting end determining the quantity of retransmissions of the current audio packet based on the maximum duration T₁ and the duration difference T₀ further comprising:
determining that if T₁>T₀/2, determining that a sum of the occupied storage of audio data of the determined quantity of retransmissions is equal to a buffer of the receiving end, or a difference between the sum of the occupied storage of audio data of the determined quantity of retransmissions and the buffer of the receiving end is less than the occupied storage of the audio data in the current audio packet.

5. The wireless audio transmission method according to claim 1, wherein the step of the transmitting end obtaining a maximum duration T₁ and a duration difference T₀, comprises: obtaining the maximum duration T₁ and the duration difference T₀ according to a predetermined correspondence relationship;
wherein the step of the transmitting end determining the quantity of retransmissions of the current audio packet based on the maximum duration T₁ and the duration difference T₀ comprises:
determining the quantity of retransmissions of the current audio packet according to the following relationship formula:
$${T}_{2} = {T}_{0} + ( ( {T}_{1} * n ) // {T}_{0} + 1 ) * {T}_{0} + {T}_{3}$$
wherein T₂ is the latency duration, T₃ is the duration from the time when the transmitting end transmits an audio packet to the time when the receiving end receives the audio packet, and n is the quantity of retransmissions of the current audio packet.

6. The wireless audio transmission method according to claim 5, wherein during step of performing the determined quantity of retransmissions, the receiving end does not feed back the acknowledgment packet, and the duration difference between two adjacent retransmissions is T₁-T₄, wherein T₄ is the transmission duration of the acknowledgment packet.

7. The wireless audio transmission method according to claim 5, further comprises:
after confirming that the determined quantity of retransmissions are completed, and if the receiving end has not received the current audio packet, copying the audio data of the previous audio packet and using the copied audio data as the audio data of the current audio packet.

8. The wireless audio transmission method according to claim 5, wherein during the step of performing the determined quantity of retransmissions, the transmitting end performs lossless encoding on the audio data of the current audio packet and then performs retransmission.

9. An audio device, comprising a memory and a processor, wherein the memory stores an audio transmission program, and when the audio transmission program is executed by the processor, a wireless audio transmission method is performed, wherein the wireless audio transmission method comprises:
a transmitting end transmitting a current audio packet to a receiving end;
the transmitting end obtaining a maximum duration T₁ and a duration difference T₀, wherein the maximum duration T₁ refers to a duration from a time when the transmitting end transmits an audio packet to a time when the transmitting end receives an acknowledgment packet fed back by the receiving end, the duration difference T₀ refers to a difference between transmission times of two adjacent audio packets transmitted by the transmitting end;
the transmitting end determining whether the acknowledgment packet is received within the maximum duration T₁;
if the acknowledgment packet is received within the maximum duration T₁, the transmitting end transmitting a next audio packet to the receiving end;
if the acknowledgment packet is not received within the maximum duration T₁, the transmitting end determining a quantity of retransmissions of the current audio packet based on the maximum duration T₁ and the duration difference T₀, and performing the determined quantity of retransmissions; and
after confirming that the determined quantity of retransmissions are completed, the transmitting end transmitting the next audio packet to the receiving end.

10. The audio device according to claim 9, wherein the step of the transmitting end determining the quantity of retransmissions of the current audio packet based on the maximum duration T₁ and the duration difference T₀ comprises:
determining that if T₁≤T₀/2, the quantity of retransmissions of the current audio packet is set to be 1, or determining that (T₁*n)≤T₀, wherein n is the quantity of retransmissions of the current audio packet.

11. The audio device according to claim 9, wherein the step of the transmitting end determining the quantity of retransmissions of the current audio packet based on the maximum duration T₁ and the duration difference T₀ comprises:
determining that if T₁>T₀/2, the quantity of retransmissions of the current audio packet is set to be 1.

12. The audio device according to claim 9, wherein the step of the transmitting end determining the quantity of retransmissions of the current audio packet based on the maximum duration T₁ and the duration difference T₀ further comprises:
determining that if T₁ >T₀/2, determining that a sum of the occupied storage of audio data of the determined quantity of retransmissions is equal to a buffer of the receiving end, or a difference between the sum of the occupied storage of audio data of the determined quantity of retransmissions and the buffer of the receiving end is less than the occupied storage of the audio data in the current audio packet.

13. The audio device according to claim 9, wherein the step of the transmitting end obtaining a maximum duration T₁ and a duration difference T₀, comprises: obtaining the maximum duration T₁ and the duration difference T₀ according to a predetermined correspondence relationship;
wherein the step of the transmitting end determining a quantity of retransmissions of the current audio packet based on the maximum duration T₁ and the duration difference T₀ comprises:
determining the quantity of retransmissions of the current audio packet according to the following relationship formula:
$${T}_{2} = {T}_{0} + ( ( {T}_{1} * n ) // {T}_{0} + 1 ) * {T}_{0} + {T}_{3}$$
wherein T₂ is the latency duration, T₃ is the duration from the time when the transmitting end transmits an audio packet to the time when the receiving end receives the audio packet, and n is the quantity of retransmissions of the current audio packet.

14. The audio device according to claim 13, wherein during step of performing the determined quantity of retransmissions is executed, the receiving end does not feed back the acknowledgment packet, and the duration difference between two adjacent retransmissions is T₁-T₄, wherein T₄ is the transmission duration of the acknowledgment packet.

15. The audio device according to claim 13, wherein the method further comprises:
after determining that the determined quantity of retransmissions are completed, and if the receiving end has not received the current audio packet, copying the audio data of the previous audio packet and using the copied audio data as the audio data of the current audio packet.

16. The audio device according to claim 13, wherein during the step of performing the determined quantity of retransmissions, the transmitting end performs lossless encoding on the audio data of the current audio packet and then performs retransmission.

17. A non-transitory computer-readable storage medium, being configured to store a computer program, and when the computer program is executed by a processor, a wireless audio transmission method is performed, wherein the wireless audio transmission method comprises:
a transmitting end transmitting a current audio packet to a receiving end;
the transmitting end obtaining a maximum duration T₁ and a duration difference T₀, wherein the maximum duration T₁ refers to a duration from a time when the transmitting end transmits an audio packet to a time when the transmitting end receives an acknowledgment packet fed back by the receiving end, the duration difference T₀ refers to a difference between transmission times of two adjacent audio packets transmitted by the transmitting end;
the transmitting end determining whether the acknowledgment packet is received within the maximum duration T₁;
if the acknowledgment packet is received within the maximum duration T₁, the transmitting end transmitting a next audio packet to the receiving end;
if the acknowledgment packet is not received within the maximum duration T₁, the transmitting end determining a quantity of retransmissions of the current audio packet based on the maximum duration T₁ and the duration difference T₀, and performing the determined quantity of retransmissions; and
after confirming that the determined quantity of retransmissions are completed, the transmitting end transmitting the next audio packet to the receiving end.

18. The non-transitory computer-readable storage medium according to claim 17, wherein the step of the transmitting end determining the quantity of retransmissions of the current audio packet based on the maximum duration T₁ and the duration difference T₀ comprises:
determining that if T₁≤T₀/2, the quantity of retransmissions of the current audio packet is set to be 1, or determining that (T₁*n)≤T₀, wherein n is the quantity of retransmissions of the current audio packet.

19. The non-transitory computer-readable storage medium according to claim 17, wherein the step of the transmitting end determining the quantity of retransmissions of the current audio packet based on the maximum duration T₁ and the duration difference T₀ comprises:
determining that if T₁>T₀/2, the quantity of retransmissions of the current audio packet is set to be 1.

20. The non-transitory computer-readable storage medium according to claim 17, wherein the step of the transmitting end determining the quantity of retransmissions of the current audio packet based on the maximum duration T₁ and the duration difference T₀ further comprises:
determining that if T₁>T₀/2, determining that a sum of the occupied storage of audio data of the determined quantity of retransmissions is equal to a buffer of the receiving end, or a difference between the sum of the occupied storage of audio data of the determined quantity of retransmissions and the buffer of the receiving end is less than the occupied storage of the audio data in the current audio packet.
